(19) United States
(12) Patent Application Publication
(10) Pub. No.: US 2026/0140421 A1
(43) Pub. Date: May 21, 2026

(54) AN ELECTROWETTING OPTICAL ELEMENT

(71) Applicant: MIORTECH HOLDING B.V., Eindhoven (NL)

(72) Inventors: Johannes Marra, Eindhoven (NL); Hermanus FEIL, Eindhoven (NL)

(21) Appl. No.: 19/123,229

(22) PCT Filed: Oct. 30, 2023
(86) PCT No.: PCT/NL2023/050566

§ 371 Date: Apr. 22, 2025

(30) Foreign Application Priority Data
Oct. 28, 2022 (NL) 2033418

(51) Int. Cl. G02F 1/166; G02F 1/1676; G02F 1/1681

(52) U.S. Cl. CPC G02F 1/166; G02F 1/1676; G02F 1/1681

(57) ABSTRACT

An electrowetting optical element having a first electrode layer stack including a substrate and a first electrode layer, a second electrode layer stack including a superstrate and a second electrode layer, a containment space formed between the first and second electrode layer stacks, and one or more cell walls extending between the first and second electrode stacks forming cells. The containment space includes a polar liquid and a non-polar liquid immiscible with each other, wherein the first and second electrode layers are configured to apply a voltage between the electrodes for rearranging the polar liquid relative to the non-polar liquid. The first electrode layer stack includes an insulating layer disposed between the first electrode layer and the containment space, wherein the insulating layer includes a first and a second group of polymers arranged in the insulating layer as an entangled polymeric network.

### DESCRIPTION

The present disclosure relates, in general, to an electrowetting optical element and to a method for processing an electrode layer stack in such an electrowetting optical element. The present disclosure relates more in particular to an insulating layer comprised in an electrode layer stack in such an electrowetting optical element wherein the insulating layer improves the optical element's operational reliability throughout a wide temperature range.

The present disclosure further relates to a method for processing such an electrode layer stack in an electrowetting optical element as well as in a display comprising such elements. Electrowetting is based on the modification of the effective wetting preference of a hydrophobic surface of an insulating layer for a non-polar liquid relative to that for a polar liquid by means of altering the strength of an applied electric field across the insulating layer. The insulating layer, the polar liquid and the non-polar liquid are thereby part of a capacitor assembly which also comprises electrodes between which a voltage can be applied for establishing an electric field across the insulating layer.

An electrowetting optical element, which in the present disclosure may also be referred to as an electrowetting element according to the state of the art may, from bottom to top, i.e. from a reverse viewing path, be comprised of respectively a first electrode layer stack and a second electrode layer stack. The first electrode layer stack comprises at least a substrate, a first electrode layer and an electrically insulating layer on top of the first electrode layer. The second electrode layer stack comprises at least a superstrate and a second electrode layer.

Between the first and the second electrode layer stack a containment space is formed in which a polar liquid and a non-polar liquid are contained between a plurality of cell walls which extend between the first and the second electrode layer stack. The polar liquid and the non-polar liquid are immiscible with each other. Between these cell walls and the first and the second electrode layer stack individual cells are formed. At least one cell but preferably multiple cells together may define an individual pixel in the optical device in which the electrowetting optical element is disposed. A pixel is considered the smallest addressable element of a display and thus, in the present disclosure, a pixel element comprises at least one electrowetting cell. A pixel may contain one but also an arbitrary number of cells, for example an even number of cells or an odd number of cells.

It is expressed that the definition of containment space is to be interpreted in a functional and non-limiting manner. This means that the polar or non-polar liquid may flow freely or partly from one part of the containment space to another part of the containment space. To allow or promote such migration, the cell walls disposed between the first and second electrode layer stack do not fully encapsulate the polar and non-polar liquid within the containment space but allow a full or a restricted migration of liquids from one cell to neighbouring cells and thus from one part of the containment space to neighbouring parts of the containment space. The definition of containment space is thus used as a known definition but not limited to examples which prevent any migration of liquid between adjacent containment spaces.

The above described electrowetting elements are known, for example from U.S. Pat. No. 9,274,331B2 , having the same applicant as the present disclosure. The electrowetting element disclosed therein is arranged for enabling the powering of the first and the second electrode layer for rearranging the polar liquid relative to the non-polar liquid. The element has a first and a second electrode layer stack and cell walls with a typical configuration wherein the cell walls extend between the first and the second electrode layer stack and wherein the cell walls are fixedly mounted on the second electrode layer stack but non-fixedly mounted on the first electrode layer stack. This non-fixedly mounting may also be referred to as the end face of the cell walls facing the first electrode layer stack in such a way that they contact the first electrode layer stack in a loose manner.

The insulating layer in the first electrode layer stack is thus, as mentioned, electrically insulating to substantially prevent electrical conduction and/or short-circuiting between the first electrode layer and the polar liquid in the containment space. The insulating layer may also feature a hydrophobic interface with the containment space comprising the polar and non-polar liquids.

It has been found that known electrowetting displays comprising such electrowetting optical elements suffer from deterioration during operation of the display at elevated temperatures.

At room temperature, the electrowetting displays may operate correctly but, especially relevant for outdoor applications, when the temperate rises above room temperature or drops substantially, the electrowetting behaviour of the display is observed to deteriorate.

The present disclosure has for its object to obviate the above-mentioned problems and disadvantages of the prior art and, more in particular, to provide an electrowetting optical element having an improved and more reliable electrowetting effect at temperatures that markedly differ from room temperature.

The present invention further has for its object to provide a method of manufacturing or processing an electrowetting optical element having an improved and more reliable electrowetting effect at temperatures that markedly differ from room temperature.

In accordance with a first aspect of the present disclosure the above-mentioned object is achieved by an electrowetting optical element, comprising:
a first electrode layer stack comprising a substrate and a first electrode layer;
a second electrode layer stack comprising a superstrate and a second electrode layer;
a containment space formed between said first and second electrode layer stack;
one or more cell walls extending between said first and second electrode stacks for defining sides of said containment space forming cells;
said containment space comprising a polar liquid and a non-polar liquid, the polar and non-polar liquids being immiscible with each other;
wherein said first and second electrode layers are arranged for applying a voltage between said electrodes for rearranging said polar liquid relative to said non-polar liquid;
wherein said first electrode layer stack further comprises an insulating layer disposed between said first electrode layer and said containment space, forming an interface with said containment space, wherein said insulating layer comprises a first and a second group of polymers, said first group of polymers comprising functional hydrophilic chemical groups arranged for forming covalent bonds with said first electrode layer stack, and said second group comprising polymers without functional hydrophilic chemical groups and wherein said first and second group of polymers are arranged in said insulating layer as an entangled polymeric network.

The principles of operation of an electrowetting element are as follows. In the unpowered state or disabled powering modus of the first and second electrode, i.e. when no voltage is applied between the first and second electrode, the system is in its lowest energetic state when the non-polar liquid forms a boundary layer between the polar liquid and the hydrophobic surface of the insulating layer. This is because of the preferential wetting of the hydrophobic surface by the non-polar liquid which effectively repels the polar liquid from contact with the hydrophobic surface. Provided that the non-polar liquid is an optically absorbing liquid across at least part of the visible wavelength region, the optical absorption of the non-polar liquid then forms an obstruction to incident light that penetrates the system, thereby creating an electrowetting element that has a reduced optical transmission across at least part of the visible wavelength region. When a voltage is applied between the first and the second electrode, an electric field is set up between the second electrode (in short-circuit with the conducting polar liquid) and the first electrode across the combined thickness of the insulating layer and the non-polar liquid, and the lowest energetic state of the system becomes the situation wherein the poorly conductive or insulating non-polar liquid has at least partly been pushed aside by the conductive polar liquid through the force of the applied electric field. Effectively, the application of a voltage between the electrodes reduces the preferential wetting of the hydrophobic surface by the non-polar liquid. Provided that the applied voltage is large enough, the hydrophobic surface becomes preferentially wetted by the polar liquid thereby largely displacing the non-polar liquid from the hydrophobic surface. Inside the electrowetting cell, the shape of the displaced non-polar liquid is thereby transformed from a lens-shaped liquid film into a contracted droplet. In this situation, provided that the polar liquid is a substantially optically non-absorbing liquid across the visible wavelength region, incident light that penetrates the system suffers less from optical absorption by the non-polar liquid, thereby enhancing the optical transmission of incident light by the electrowetting element.

Upon switching the electrodes from the powered state back to the non-powered state, by taking away the voltage that is applied between the electrodes, the electric field across the insulating layer is nullified and the system turns back to the lowest energetic state of the system that was present before the electrodes were powered wherein the hydrophobic layer is preferentially wetted by the non-polar liquid in the shape of a non-polar liquid film, thereby displacing the polar liquid from the hydrophobic surface of the insulating layer.

It has been found that for the realization of an electrowetting element capable of maintaining the structural integrity of the insulating layer and its high degree of hydrophobicity during its electrowetting operation in the course of time throughout a wide temperature interval ranging from approximately −30 degrees Celsius up to 70 degrees Celsius, the physical and chemical characteristics of the insulating layer play an important role.

Prior art insulating layers comprising mainly inorganic materials notoriously suffer from defects and pinholes in the inorganic part of the insulating layer, which easily give rise to conduction currents and/or short-circuits during electrowetting operation when a potential difference is applied across the insulating layer.

Prior art hydrophobic hydrocarbon or fluorocarbon monolayers disposed on top of an insulating organic or inorganic layer are experienced to quickly suffer from chemical deterioration during electrowetting operation, particularly during operation at elevated (outdoor) temperatures. Chemical deterioration of the interface between the insulating layer and the polar liquid tends to make the interface more hydrophilic which compromises the electrowetting behaviour in response to the applied electric potential difference across the insulating layer: it is essential that the interface is capable of preserving a highly hydrophobic character during electrowetting operation in the course of time throughout a broad temperature range.

Insulating layers used in known devices may comprise only a single thick layer of fluorocarbon material such as Teflon AF (Dupont), Cytop-S (AGC Chemicals Company) or Fluoropel (Cytonics). Such insulating layers are known to experience problems with their adhesion to the electrode material and are furthermore known to suffer from pinholes and defects.

It has been found that an insulating layer comprised of a layer of these fluorocarbon materials typically lack functional chemical groups capable of bonding to the electrode material, e.g. to form covalent bonds with hydroxyl groups on the electrode (ITO) surface and/or the glass substrate surface, such that adhesion problems with the electrode material may be experienced and delamination may occur.

On the other hand, an insulating polymeric material having the capability of bonding to electrode and/or glass surfaces is known as Cytop-M (AGC Chemicals company). Cytop-M possesses functional amino-silane groups attached to both ends of its polymer chain for chemical bonding to hydroxyl groups on electrode (ITO) and/or glass surfaces. However, it has been found that an insulating layer of Cytop-M material gradually loses its hydrophobicity when exposed to a polar liquid, particularly so at higher temperatures. It has been determined that the decreasing degree of hydrophobicity is due to the transfer of non-bonded hydrophilic amino-silane end-groups on the polymeric fluorocarbon chain to the interface of the insulating layer with the polar liquid. Furthermore, fluorocarbon layers composed of Cytop-M are experienced to possess many defects causing rapid electrical breakdown when used as an insulating layer.

An insulating layer comprising a chemically cross-linked hydrocarbon material covalently bonded to ITO electrode material or to another layer of inorganic insulating material disposed on the ITO electrode material can however also be achieved with parylene. Parylene is initially capable of featuring the desired electrowetting behaviour in a polar liquid environment but the parylene/polar liquid interface is experienced to gradually suffer from a degradation of its hydrophobicity presumably through hydrolysis of the parylene material, thereby creating oxygen containing hydrophilic chemical groups at the interface. The polar liquid typically comprises polar fluids such as water, ethylene-glycol and/or glycerol or mixtures thereof. The non-polar liquid is typically composed of alkane fluids such as decane and dodecane.

The electrowetting optical element according to the present disclosure comprises a first electrode layer stack and a parallel second electrode layer stack spaced at a certain distance from each other. The distance between the first and second electrode layer stack is bridged by a plurality of cell walls forming distinct spaces between the two stacks. These spaces may be referred to as cells and may be embodied as fully sealed containment spaces in which the immiscible polar and non-polar liquids are enclosed. A space may also be a containment space in which these liquids are only loosely enclosed such that one of the liquids, e.g. the polar liquid, is to a certain degree allowed to migrate to adjacent spaces. For example, the containment space may be configured in such a way that the cell walls are fixedly attached to one of the electrode layer stacks and only placed in a loose mechanical contact with the opposite electrode layer stack, the loose mechanical contact allowing the migration of a small amount of non-polar liquid to neighbouring cells or containment spaces. The present disclosure is not limited in any way to any one of these configurations but may be embodied in any configuration of the electrowetting element provided with at least a substrate and an insulating layer in its first electrode layer stack.

The first electrode layer stack comprises an insulating layer. This insulating layer is disposed on top of the stack to interface with the containment space and thus with the polar and non-polar liquids comprised in this space.

Is was the insight of the inventors that an insulating layer comprising two types of polymers having different characteristics may combine the best of two worlds such as to benefit on the one hand from a strong bonding to the first electrode layer stack, e.g. to the ITO material of the electrode layer and/or to the glass substrate, while on the other hand being capable of maintaining a high degree of hydrophobicity at the interface with the polar and non-polar liquids.

With an insulating layer comprising a first and a second group of polymers, wherein the first group of polymers comprises functional hydrophilic chemical groups capable of bonding to the first electrode layer stack, as it is arranged for forming covalent bonds with that layer stack, and wherein the second group of polymers comprises polymers without functional hydrophilic chemical groups, the hydrophobicity at the interface is maintained and degrading is prevented when polymers of the second group of polymers migrate across the insulating layer to the interface with the polar liquid because they do not possess hydrophilic chemical groups.

As the first and second group of polymers form an entangled polymeric network, a strong mechanical bond is achieved between polymers of the two groups. The first group already features a strong chemical (covalent) bonding with the first electrode layer stack and has a sufficiently long polymer chain length to allow polymers from the second group of polymers to become entangled with this first group of polymers to achieve the entangled polymeric network.

The entanglement may be defined as intermolecular chain entanglement, hence there may exist a certain level of entanglement between chains of polymers of the same group especially with long polymer chain lengths, but the polymers of the first and second group are in accordance with the present disclosure bonded by intermolecular chain entanglement.

The entanglement may be achieved or promoted through the presence of dangling loops in the chains of polymers from the first group of polymers, a loop being formed between two functional groups on a chain that are both covalently bonded to the first electrode layer stack. The loops between bonded functional groups provide space for chains of the polymers of the second group to pass through these loops during their deposition and subsequently achieve a level of entanglement. The dimensions of the loops depend on various aspects such as the number of functional hydrophilic chemical groups per unit chain length, the polymer chain length and the free volume of the polymer matrix created by the voids left between entangled polymer chains. Hence, the effective free volume or average size of the loops may be determined by the average distance between two neighbouring covalent bonds with which a single polymer chain from the first group of polymers is attached to the first electrode layer stack, as well as by the free volume which may exist between multiple polymer chains of the first group which have several covalent bonds with the first electrode layer stack. The entanglement may thus be interpreted as entanglements of polymers of the second group of polymers through loops of polymer chains of the first group of polymers on a surface of the first electrode stack or through the free volume existing between multiple polymer chains of the first group of polymers.

The polymers of the first group are deposited in such a way and to such level or height that sufficient loops or free volume is achieved for the polymers of the second group to entangle during and after their deposition. Preferably, polymers from the first group of polymers are deposited as a polymer monolayer characterized in that all deposited polymer chains are covalently bonded with the first electrode layer stack. Subsequently, polymers from the second group of polymers are deposited as a multilayer, or at least with such a volume or amount to achieve a deposited thickness which substantially exceeds the thickness of the deposited first group of polymers and by which the deposited polymers from the second group covers the deposited polymers from the first group. Preferably, the volume of second group polymers that is disposed on the first group of deposited polymers is such that a thickness is achieved which at least substantially corresponds to the extended chain length of the deposited polymers from the first group, but preferably exceeds this length. This has the effect that even if any of the deposited polymer chains of the first group would extend from a covalent bonding site attached to one end of the polymer chain towards the interface with the containment space, the opposite end of the polymer chain would not be able reach the surface of the insulating layer and thus the interface with the polar liquid because of its limited chain length. Hence, the second group of deposited polymers covers the first group of deposited polymer in a way in which these are substantially concealed and buried.

The insulating layer may thus be considered as comprising a stacked fluorocarbon layer having two sub-layers, in which the first layer comprises a first polymeric fluorocarbon having functional chemical groups arranged for forming covalent bonds with hydroxyl groups comprised in and attached to a support layer or electrode layer stack, and in which the second layer comprises a second polymeric fluorocarbon atop the first layer and preferably comprising only fluorocarbon moieties.

Preferably, the insulating layer may adhere or bond to a support layer comprised in the first electrode layer stack, which support layer may be formed by any or more of the following materials:
the electrode material on the substrate surface,
an inorganic non-metallic material,
an organic material, preferably a chemically cross-linked organic material, wherein the material forming the support layer, other than the electrode material itself, is ionically or covalently bonded to the electrode material on the substrate surface. In case the electrode material on the substrate surface is present as a patterned electrode material on glass, the support layer is also ionically or covalently bonded to the glass.

In an example, the first and second group of polymers have polymer chains comprising at least 100 monomers, preferably at least 250 monomers, more preferably at least 500 monomers.

In an example, the first and second group of polymers have polymer chain lengths of at least 100 nm, preferably at least 200 nm, more preferably at least 250 nm.

Several (intrinsic) properties of the polymers may influence, determine or promote the level of entanglement between the deposited polymers of the two groups. These properties may relate to the chain length of the polymers. A longer polymer chain has the effect that it allows more free volume or loops and thus promote chain entanglement. The number of covalent bonds per polymer, hence, defined by the number of functional chemical groups per polymer chain, may also determine the degree in which the polymers of the two groups have the tendency to entangle. Accordingly, the level of entanglement may be controlled or determined by selecting one or more of the polymer chain length, the number of functional chemical groups per polymer chain, and thereby the free volume in the deposited composite polymer layer and the size of the dangling loops of the deposited first group of polymers during the deposition of the second group of polymers

In an example, the deposited polymers from the first group of polymers are present as a monolayer of polymers characterized in that the polymers in said monolayer are all covalently bonded to the first electrode layer stack.

In an example, the deposited polymers from the second group of polymers are present as a multilayer of polymers.

Preferably, the layer thickness of the deposited polymers from the first group of polymers is thinner than the layer thickness of the deposited polymers from the second group of polymers. More specifically, the first group of polymers may be substantially deposited as a monolayer, whereas the second group of polymers may be deposited as a thicker multilayer. At the interface between the said monolayer and the said multilayer, the deposited first and second group of polymers are present as an entangled matrix.

In an example, the deposited entangled polymeric network comprises a monolayer of the first group of polymers having covalent bonds with functional chemical groups on the first electrode layer stack, and a multilayer of the second group of polymers entangled with the first group of polymers through dangling polymer chain loops of the first group of polymers, both ends of the loops attached to functional chemical groups on the first electrode layer stack.

In an example, the second group of polymers comprises polymers composed of hydrophobic chemical moieties.

In an example, the first group of polymers comprises polymers possessing a single functional chemical end-group arranged for forming a covalent bond with a hydroxyl group comprised in and attached to the first electrode layer stack.

In an example, the first group of polymers comprises two single functional end-groups arranged for forming covalent bonds with hydroxyl groups comprised in and attached to the first electrode layer stack.

The first group of polymers comprises at least a single but preferably several functional chemical groups on each polymer chain. Polymers with several of such functional chemical groups which are arranged to form a covalent bond with hydroxyl groups on the first electrode layer stack have the effect that they promote a stronger bonding of the first group of deposited polymers to the first electrode layer stack as compared to polymers having only one of such functional chemical groups.

In an example, the first electrode layer stack furthermore comprises a support layer disposed between the first electrode layer and the insulating layer and comprising one or more materials chosen from the group formed by inorganic non-metallic materials with a high electrical resistivity, and organic materials, more preferably chemically cross-linked organic materials with a high electrical resistivity.

The insulating layer may also be (covalently) bonded to the stack through a support layer, which preferably is formed of organic or inorganic non-metallic materials.

In an example, the support layer comprises organic parylene, and preferably organic parylene which is covalently bonded to hydroxyl groups comprised in and attached to the first electrode layer, the covalent bonding preferably enabled through a silane adhesion promotor.

In an example, the parylene is parylene-C, more preferably parylene-N, most preferably parylene-HT.

Parylene is initially capable of enabling the desired electrowetting behaviour in a polar liquid environment but the parylene/polar liquid interface is experienced to gradually suffer from a degradation of its hydrophobicity presumably through hydrolysis of the parylene material, thereby creating oxygen containing hydrophilic chemical groups at the interface which deteriorates the hydrophobic nature of this interface exposed to the polar and non-polar liquids.

A support layer embodied as an inorganic multilayer stack is known to feature far fewer defects compared to a single inorganic layer, but the deposition process is too costly to be practical. Also an inorganic multilayer stack requires a topcoat with a fluorocarbon material in such a way that the fluorocarbon material does not suffer from the above-mentioned fluorocarbon issues that sooner or later compromises the electrowetting behaviour.

In an example, one or both of the first and second group of polymers comprises fluoropolymers, the fluoropolymers having at least one or more characteristics of optical transparency, electrical insulation, high hydrophobicity, and high chemical resistance.

In an example, the first group of polymers is comprised of Cytop-M.

In an example, the second group of polymers is solely comprised of fluorocarbon moieties.

In an example, the second group of polymers is comprised of Cytop-S.

In a further aspect, the present disclosure provides a method for processing an electrode layer stack for the manufacturing of an electrowetting optical element comprising the steps of:
providing an electrode layer stack comprising a substrate and an electrode layer;
providing an insulating layer on the electrode layer stack, for forming an interface with a containment space within the electrowetting optical element; wherein the insulating layer is formed by the successive steps of:
depositing a first group of polymers on the electrode layer stack, wherein the first group of polymers comprises at least one functional hydrophilic chemical group arranged for forming covalent bonds with hydroxyl groups comprised in and attached to the electrode layer stack;
removing those polymers of the first group which are not covalently bonded to the electrode layer stack;
depositing a second group of polymers on the electrode layer stack, wherein the second group of polymers comprises polymers without having functional hydrophilic chemical groups,
   for the first and second group of polymers to become entangled as a polymeric network in the insulating layer.

In an example, the first and the second groups of polymers are deposited by means of wet-chemical dip-coating from the corresponding polymer solutions.

In an example, part of the first group of polymers is removed by dipping the electrode layer stack in a fluorocarbon solvent arranged for dissolving the polymers of the first group of polymers to dissolve and remove those polymers of the first group which are not covalently bonded to hydroxyl groups comprised in and attached to the electrode layer stack.

In an example, between the step of depositing the first group of polymers and the removing part of the first group of polymers, the method further comprises a step of:
annealing the electrode layer stack comprising the first group of polymers, and wherein the step of annealing is preferably performed at an elevated temperature of >100° C.

In an example, prior to the step of providing the insulating layer, the method further comprises the step of:
chemically-activating the first electrode layer for enabling the covalent bonding with the first group of polymers.

In an example, prior to the step of providing the insulating layer, the method further comprises the successive steps of:
providing a support layer on the first electrode layer, the support layer comprising one or more materials chosen from the group formed by inorganic non-metallic materials with a high electrical resistivity and organic materials, more preferably chemically cross-linked organic materials possessing a high electrical resistivity;
chemically-activating the surface of the support layer for enabling the covalent bonding with the first group of polymers in the insulating layer.

In an example, the chemically-activating is arranged by providing it with hydroxyl groups.

In an example, the support layer is an organic parylene layer that is covalently bonded to hydroxyl groups on the ITO material of the substrate electrode by means of the silane A-174 adhesion promotor during the parylene deposition. The chemical activation serving to hydrophilize the substrate electrode material enables a higher density of silane A-174 molecules to be covalently bonded to the electrode material, thereby enabling an improved adhesion of the parylene layer to the substrate electrode. After its deposition, the parylene layer itself is activated by providing it with a controlled surface density of hydroxyl groups on its surface by means of a judiciously-chosen UV-O₃ or oxygen-plasma treatment. These hydroxyl groups are capable of forming covalent bonds with reactive silane groups attached to the backbone of the first polymeric fluorocarbon material when, after its deposition on the activated parylene layer (f.i. by means of dip-coating), a first anneal at T>100° C. is carried out, preferably in an oxygen-free environment. Subsequently, all fluorocarbon material that has not been covalently bonded to the parylene is removed by dipping the substrate in a fluorocarbon solvent capable of dissolving the first polymeric fluorocarbon material. Only covalently bonded fluorocarbon material is then left on the parylene layer, effectively forming the first fluorocarbon sub-layer comprising a polymeric fluorocarbon monolayer lying flat on the parylene surface after removing the solvent through evaporation and through annealing the first fluorocarbon sub-layer at a temperature T>100° C. Subsequently, the second fluorocarbon sub-layer is cast on the first fluorocarbon sub-layer, the second fluorocarbon material preferably featuring the same fluorocarbon material as the first fluorocarbon material except that it is not provided with reactive silane groups or other hydrophilic chemical groups. During the deposition of the second fluorocarbon material from a fluorocarbon solvent, the first polymeric fluorocarbon material again surrounds itself with solvent molecules and partially detaches from the support surface thereby forming dangling loops between two covalently-bonded sites on its backbone. This allows the second polymeric fluorocarbon material to become entangled with the first polymeric fluorocarbon material during its deposition in the presence of the fluorocarbon solvent, the entanglement becoming frozen-in when the solvent is subsequently removed during a subsequent second anneal of the entangled polymeric network at T>100° C., the second anneal preferably carried out in an inert oxygen-free environment. The second fluorocarbon sub-layer is substantially thicker than the first fluorocarbon sub-layer to prevent any non-reacted functional groups on the first polymeric fluorocarbon material to become exposed to the interface of the composite fluorocarbon layer with the polar liquid in the electrowetting display. The result is a composite fluorocarbon layer that is firmly anchored to the support layer while capable of maintaining a hydrophobic interface with the polar liquid. The support layer is firmly anchored to the substrate electrode material.

In an example, a method for processing an electrode layer stack for the manufacturing of an electrowetting optical element comprises the steps of:
providing an electrode layer stack comprising a substrate and an electrode layer;
providing cells walls on said electrode layer stack and extending from said electrode layer stack defining a three-dimensional non-planar topographic surface, for at least partially defining a containment space encapsulating a polar liquid and a non-polar liquid;
providing an insulating layer on the electrode layer stack, over said electrode layer and said cell walls, for forming an interface with said containment space;
wherein the insulating layer is formed by the successive steps of:
depositing a first group of polymers on the electrode layer stack, wherein the first group of polymers comprises at least one functional hydrophilic chemical group arranged for forming covalent bonds with hydroxyl groups comprised in and attached to the electrode layer stack;
removing those polymers of the first group which are not covalently bonded to the electrode layer stack;
depositing a second group of polymers on the electrode layer stack, wherein the second group of polymers comprises polymers without having functional hydrophilic chemical groups,
for the first and second group of polymers to become entangled as a polymeric network in the insulating layer.

The insulating interface layer in accordance with the present disclosure, formed by depositing two groups of polymers, for example Cytop-M and Cyto-S, may be formed on a flat planar two dimensional surface of the electrode layer, but according to the above example, also be formed on a non-flat, non-planar three-dimensional surface. When the cell walls are provided on the electrode layer, the planar surface of the electrode layer becomes an embossed surface having raised cell walls and recessed cells defining the containment space in which the polar and non-polar liquids are encapsulated.

The insulating interface layer in accordance with the present disclosure formed by depositing two groups of polymers, for example Cytop-M and Cytop-S, may alternatively be disposed on top of a support layer formed by one or more of the materials from the group comprising inorganic non-metallic materials and an organic material, preferably a chemically cross-linked organic material, wherein the support layer is ionically or covalently bonded to the electrode layer material and to the cell wall material when cell walls are provided on the electrode layer.

In yet another aspect of the present disclosure, there is provided an electrowetting optical display comprising one or more electrowetting optical elements according to any of the previous aspects or examples thereof.

Each of the examples described in relation to the first aspect of the invention is also applicable in relation to the second or other aspects of the invention. Correspondingly, all advantages of the first aspect and further examples thereof also apply to the second or other aspect and its examples or examples of the first aspect.

The invention will further be described with reference to the enclosed drawings wherein embodiments of the invention are illustrated, and wherein:

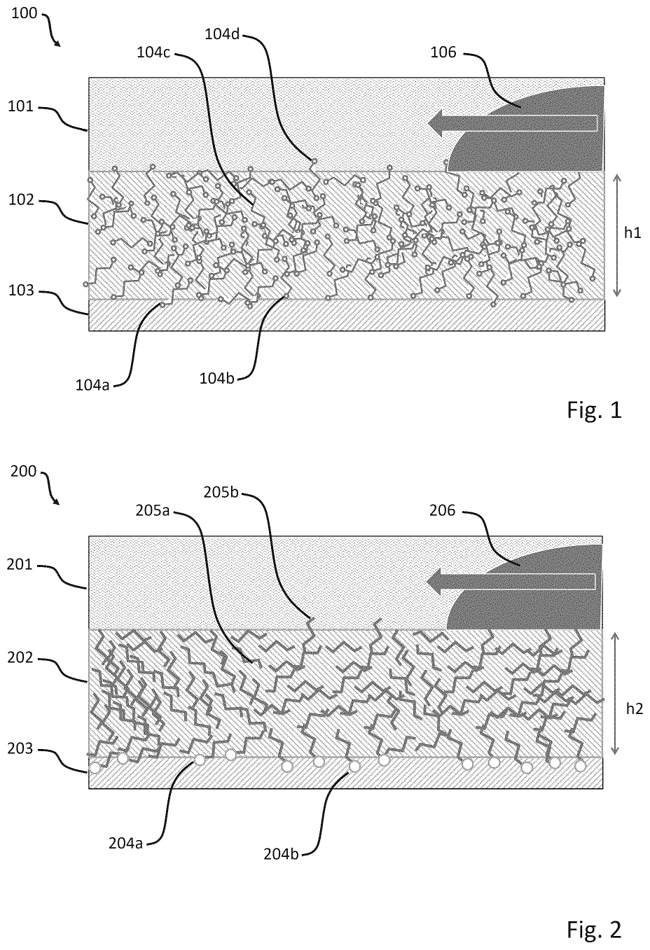

FIG. 1 shows in an illustrative manner, an electrode layer stack of an electrowetting element according to the prior-art;

FIG. 2 shows in an illustrative manner, an electrode layer stack of an electrowetting element according to the present disclosure;

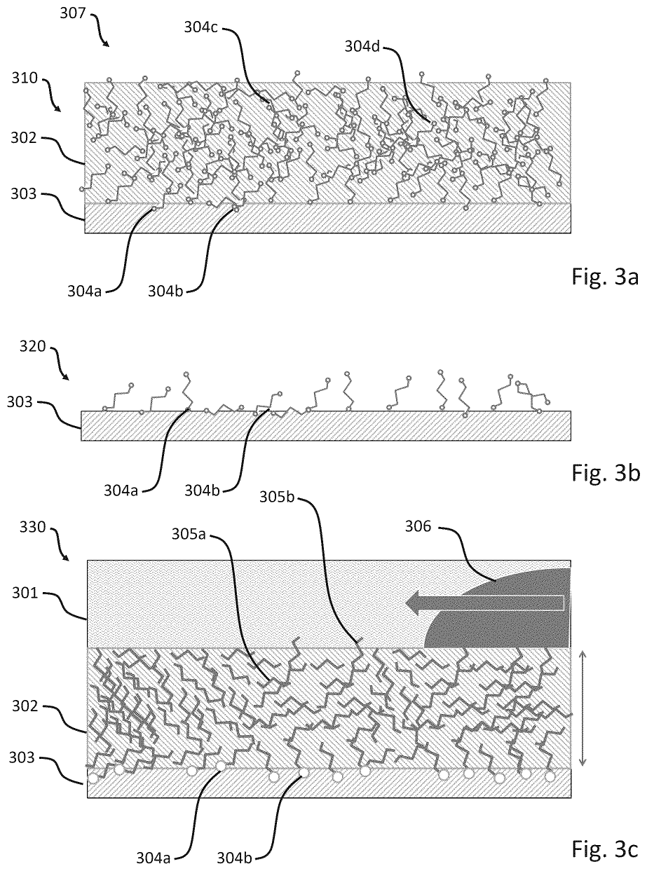

FIG. 3a-c show several steps of processing an electrode layer stack of an electrowetting element according to the present disclosure;

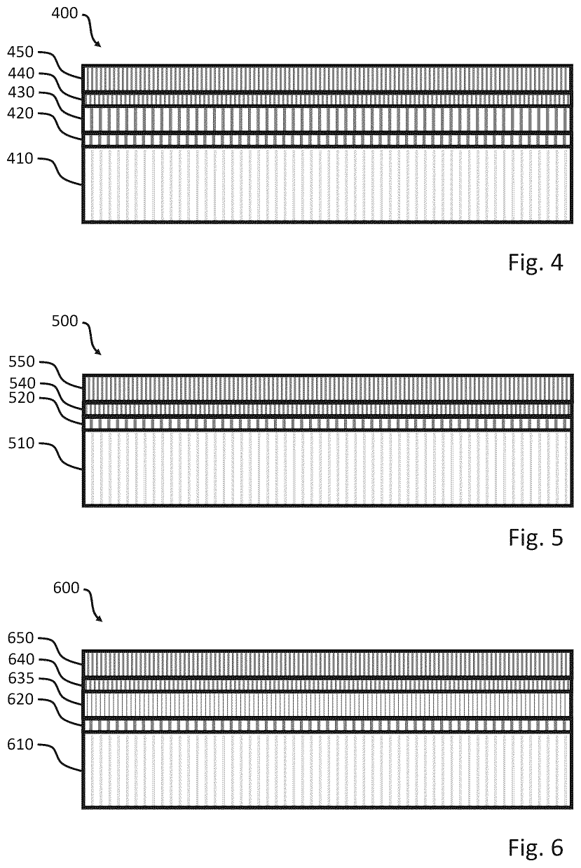

FIGS. 4, 5 and 6 show in an illustrative manner, several embodiments of an electrode layer stack of an electrowetting element according to the present disclosure.

FIG. 1 shows a detail of an electrowetting optical element or further also referred to as electrowetting element according to the state of the art. An electrowetting display (EWD) comprises electrowetting optical elements which comprise a transparent substrate plate, a transparent superstrate plate aligned in parallel to the substrate plate, and a liquid layer sandwiched between these two plates. Both plates are provided with electrodes facing the liquid layer, the liquid layer comprising a transparent polar liquid layer and a colored non-polar liquid which is immiscible with the polar liquid. The substrate plate is furthermore provided with an insulating layer disposed on the substrate electrode.

As shown in FIG. 1, the insulating layer 102 separates the polar liquid, which is in electric short-circuit contact with the superstrate electrode, from the substrate electrode layer 103, or from a support layer 103 on top of the substrate electrode layer. A potential difference is set up across the insulating layer 102 when the substrate and superstrate electrodes are set at different electric potentials. The materials and thickness of the insulating layer are to be chosen such as to minimize the chance of issues such as electric breakdown and/or the occurrence of a leakage current across the insulating layer at the maximum applied potential drop. These issues typically result from defects in the insulating layer.

The non-polar liquid 106 is a colored oil residing at the interface between the insulating layer 102 and the polar liquid layer. In the element, it is desirable that the oil fully spread across the interface between the insulating layer 102 and the polar liquid layer (i.e. full wetting at a substantially zero contact angle) when the electric potential drop across the insulating layer is zero. This is enabled by ensuring the insulating layer surface exposed to the polar liquid to be hydrophobic in nature.

When a potential difference is set up across the insulating layer by imposing different electric potentials to the substrate and superstrate electrodes, the oil layer on the insulating layer breaks up into droplets, the droplets assuming a non-zero contact angle (i.e. a partial wetting) on the insulating layer in the polar liquid environment, the contact angle increasing along with an increasing potential difference. This is known as the electrowetting effect, a key aspect of the EWD operation which is extensively documented in the literature. A partial oil wetting of the oil on the insulating layer makes the EWD partially transparent, a full oil wetting makes the EWD opaque to a degree determined by the color of the oil and the thickness of the oil layer.

A prior art electrowetting element may comprise an insulating layer that is either fully composed of a hydrocarbon material, or fully composed of a fluorocarbon material, or composed of at least two dissimilar materials. In the latter case, insulating layers are disclosed comprising an organic or inorganic support layer in contact with the substrate electrode and a hydrophobic organic top layer in contact with the oil and the polar liquid. The hydrophobic top layer can be a silane-type hydrocarbon monolayer or a fluorocarbon monolayer or a thicker hydrocarbon or fluorocarbon layer deposited by means of a coating process.

FIG. 1 shows a detail of such a prior art electrowetting element, and in particular the way in which the insulating layer 102 is composed. The insulating layer 102 of the FIG. 1 is composed of fluorocarbon polymers 104a-d having chemical functional (end-)groups (illustrated with the open dots), capable of forming covalent bonds with hydroxyl groups on the layer below the insulating layer 102, e.g. on the glass substrate layer or on the ITO electrode layer 103 or on the support layer 103 disposed on the ITO electrode layer. As seen in FIG. 1 some of the polymers 104a, 104b have formed such covalent bonds with layer 103, whereas others have not 104c, 104d.

When the insulating layer 102 is comprised of only a single fluorocarbon material, by example, comprising Cytop-M (AGC Chemicals Company), it possesses functional silane groups for chemical bonding to the ITO or glass but is observed to gradually lose its hydrophobicity when exposed to a polar liquid, particularly so at higher temperatures. This is shown in FIG. 1, wherein some of the polymers 104c, 104d of the insulating layer 102 migrate to the surface and decrease the degree of hydrophobicity as hydrophilic non-reacted functional silane groups on the polymeric fluorocarbon surface in contact with the polar liquid. Furthermore, fluorocarbon layers are experienced to possess many defects causing rapid electrical breakdown when used as an insulating layer. As a result, its structural integrity and hydrophobicity cannot be maintained resulting in a deteriorating electrowetting effect.

In FIG. 2 an example is shown of an electrowetting element 200 according to an aspect of the present disclosure. The insulating layer of the element 200 shown in FIG. 2 comprises a transparent layer of substrate electrode material that may be chemically activated to provide it with a high surface density of hydroxyl groups as to induce a high degree of surface hydrophilicity. On top of the electrode layer, a chemically-activated support layer 203 may be provided. The activation thereof provides it with hydroxyl groups on its surface facing away from the substrate electrode. On top of the support layer 203 an insulating layer 202 is provided. The insulating layer 202 comprises a composite fluorocarbon layer on the activated support layer 203 having a mixture of two groups of polymers. The first group of polymers is formed by polymeric fluorocarbon material capable of forming covalent bonds with hydroxyl groups on the support layer via a single functional chemical end-group attached to each polymeric chain. These are illustrated by polymers 204a, 204b. The second group of polymers formed atop the first group comprises a second polymeric material only comprising fluorocarbon moieties 205a, 205b and therefore not capable of forming covalent bonds with hydroxyl groups on the support layer 203.

The first and second group are capable of mixing with each other, thereby forming an entangled polymeric network 204, 205, thereby creating a firm adhesive contact between the said fluorocarbon sub-layers wherein the first group of fluorocarbon material is present as a polymeric monolayer provided with functional chemical groups capable of forming covalent chemical bonds to hydroxyl groups on the surface of the support layer, and the second group of fluorocarbon material is present as a polymeric multilayer not possessing functional chemical groups or other hydrophilic chemical groups.

The insulating layer may be directly formed on top of the electrode layer, e.g. the ITO electrode, but also on top of a support layer formed by one or more of the materials from the group comprising inorganic non-metallic materials and an organic material, preferably a chemically cross-linked organic material.

The material forming the support layer, other than the electrode material itself, is ionically or covalently bonded to the electrode material on the substrate surface. In case the electrode on the substrate surface is present as a patterned electrode on glass, the support layer is also ionically or covalently bonded to the glass.

In FIG. 3a-3c the steps are shown of processing an electrode layer stack and in particular forming an insulating layer on an electrode layer stack for an electrowetting optical element in accordance with the present disclosure.

In the first step, an electrode layer stack is provided comprising a substrate and an electrode layer. On top thereof an insulating layer is provided for forming an interface with a containment space, which is during this processing step not yet formed but air 307 is initially present.

The insulating layer is formed by first depositing, e.g. by means of dip-coating, the first group of polymers. The hydroxyl groups on the support layer 303, e.g. composed of parylene, are capable of forming covalent bonds 304a, 304b with the first group of polymers, e.g. the reactive silane groups attached to the backbone of the first polymeric fluorocarbon material when, after its deposition on the activated parylene layer, a first anneal at T>100° C. is carried out, preferably in an oxygen-free environment.

Subsequently, all fluorocarbon material that has not been covalently bonded to the parylene is removed as shown in FIG. 3b. This may be achieved by dipping the substrate 320 in a fluorocarbon solvent capable of dissolving the first polymeric fluorocarbon material. Only covalently bonded fluorocarbon material 304a, 304b is then left on the parylene layer 303, effectively forming the first group of polymers or fluorocarbon sub-layer comprising a polymeric fluorocarbon monolayer lying flat on the parylene surface after removing the solvent by a first anneal at a temperature T>100° C.

Subsequently, the second group of fluorocarbon polymers 305a, 305b forming the second fluorocarbon sub-layer is cast on the first group 304a, 304b, of fluorocarbon polymers. The second group preferably featuring the same fluorocarbon material as the first fluorocarbon material except that it is not provided with reactive silane groups or other hydrophilic groups, as illustrated by the absence of the dots on the polymers of the second group 305a, 305b.

During the deposition of the second group of fluorocarbon material from a fluorocarbon solvent, the first polymeric fluorocarbon material surrounds itself with solvent molecules and partially detaches from the support surface thereby forming dangling loops between neighbouring covalently-bonded sites on its backbone. This allows the second polymeric fluorocarbon material to become easily entangled with the first polymeric fluorocarbon material in the presence of the fluorocarbon solvent. The entanglement becoming steady or frozen-in when the solvent is subsequently removed during a second anneal at T>100° C., the second anneal preferably carried out in an inert oxygen-free environment, thereby creating an electrowetting optical element, or more specifically, a first electrode layer stack of an electrowetting optical element having an insulating layer with improved properties as shown in FIG. 3c, with strong covalent bonded reactive silane groups downwards of the stack, and an absence of reactive silane groups or other hydrophilic groups at the top of the stack, wherein the insulating layer maintains its structural integrity by both groups of polymers to be entangled.

In FIGS. 4, 5 and 6 several embodiments are shown of a first electrode layer stack of an electrowetting element according to the present disclosure.

In FIG. 4 the insulating layer 440, 450 is disposed on top of a parylene layer 430, on top of a chemically-activated hydrophilic ITO electrode 420 on the glass substrate plate 410. The insulating layer 440, 450 comprises a composite fluorocarbon layer comprising a first sub-layer 440 of a first polymeric fluorocarbon material and a second sub-layer of a second polymeric fluorocarbon material 450.

In FIG. 5 the insulating layer 540, 550 is disposed on top of the chemically-activated hydrophilic ITO electrode 520 of the glass substrate plate 510. The insulating layer 540, 550 comprises a composite fluorocarbon layer comprising a first sub-layer 540 of a first polymeric fluorocarbon material and a second sub-layer of a second polymeric fluorocarbon material 550.

In FIG. 6 an example is shown with an insulating support layer 635. The support layer 635 is disposed on top of the chemically-activated hydrophilic ITO electrode 620 on the glass substrate plate 610. The insulating layer 640, 650 is disposed on the chemically-activated support layer 635, the insulating layer 640, 650 comprising a first sub-layer 640 of a first polymeric fluorocarbon material and a second sub-layer 650 of a second polymeric fluorocarbon material, similar to the other examples shown in FIGS. 4 and 5. The support layer 635 itself may also be a composite support layer comprising an insulating inorganic sub-layer and an insulating organic sublayer.

As will be appreciated by the person skilled in the art, the present invention may be practised otherwise than as specifically described herein. Obvious modifications to the embodiments disclosed, and specific design choices, will be apparent to the skilled reader. The scope of the invention is only defined by the appended claims.

1-25. (canceled)

26. An electrowetting optical element, comprising:
a first electrode layer stack including a substrate and a first electrode layer;
a second electrode layer stack including a superstrate and a second electrode layer;
a containment space formed between the first and second electrode layer stacks;
one or more cell walls extending between the first and second electrode layer stacks and defining sides of the containment space forming cells; and
the containment space containing a polar liquid and a non-polar liquid, wherein the polar and non-polar liquids are immiscible with each other;
wherein the first and second electrode layers are configured to apply a voltage therebetween configured to rearrange the polar liquid relative to the non-polar liquid; and
wherein the first electrode layer stack further includes an insulating layer disposed between the first electrode layer and the containment space, forming an interface with the containment space, wherein the insulating layer includes a first and a second group of polymers, the first group of polymers including functional hydrophilic chemical groups configured to form covalent bonds with the first electrode layer stack, and the second group including polymers without functional hydrophilic chemical groups, and wherein the first and second group of polymers are arranged in the insulating layer as an entangled polymeric network.

27. The electrowetting optical element according to claim 26, wherein the first and second groups of polymers have polymer chains comprising at least 100 monomers and/or the first and second groups of polymers have polymer chain lengths of at least 100 nm and/or the first group of polymers is a polymeric monolayer wherein the polymers in the polymeric monolayer are covalently bonded to the first electrode layer stack.

28. The electrowetting optical element according to claim 26, wherein the second group of polymers is a multilayer of polymers.

29. The electrowetting optical element according to claim 26, wherein the entangled polymeric network comprises a monolayer of the first group of polymers attached with covalent bonds to the first electrode layer stack, and a multilayer of the second group of polymers entangled with the first group of polymers via dangling polymer chain loops formed between two functional chemical groups on a chain of a polymer from the the first group of polymers, wherein the two functional chemical groups are both covalently bonded to the first electrode layer stack.

30. The electrowetting optical element according to claim 26, wherein the second group of polymers includes polymers composed of hydrophobic chemical moieties.

31. The electrowetting optical element according to claim 26, wherein the first group of polymers includes polymers having a single functional chemical end-group configured to form a covalent bond with a hydroxyl group comprised in and attached to the first electrode layer stack.

32. The electrowetting optical element according to claim 26, wherein the first group of polymers includes two functional end-groups configured to form covalent bonds with hydroxyl groups comprised in and attached to the first electrode layer stack.

33. The electrowetting optical element according to claim 26, wherein the first electrode layer stack includes a support layer disposed between the first electrode layer and the insulating layer and includes one or more materials chosen from the group formed by inorganic non-metallic materials having a high electrical resistivity, and organic materials.

34. The electrowetting optical element according to claim 33, wherein the support layer comprises organic parylene which is covalently bonded to hydroxyl groups comprised in and attached to the first electrode layer or covalently bonded to hydroxyl groups comprised in and attached to an inorganic non-metallic layer disposed in between the first electrode layer and the organic parylene layer.

35. The electrowetting optical element according to claim 34, wherein the organic parylene is parylene-C, parylene-N, or parylene-HT.

36. The electrowetting optical element according to claim 26, wherein at least one of the first and second group of polymers comprises fluoropolymers having at least one characteristic of optical transparency, electrical insulation, high hydrophobicity, and high chemical resistance.

37. The electrowetting optical element according to claim 26, wherein the first group of polymers is comprised of Cytop-M and/or the second group of polymers is solely comprised of fluorocarbon moieties and/or the second group of polymers is comprised of Cytop-S.

38. A method of processing an electrode layer stack for the manufacturing of an electrowetting optical element, the method comprising the steps of:
providing an electrode layer stack comprising a substrate and an electrode layer;
providing an insulating layer on the electrode layer stack, for forming an interface with a containment space within the electrowetting optical element;
wherein the insulating layer is formed by the successive steps of:
depositing a first group of polymers on the electrode layer stack, wherein the first group of polymers includes at least one functional hydrophilic chemical group configured to form covalent bonds with hydroxyl groups comprised in and attached to the electrode layer stack;
removing unbonded polymers of the first group that are not covalently bonded to the electrode layer stack;
depositing a second group of polymers on the electrode layer stack, wherein the second group of polymers includes polymers without functional hydrophilic chemical groups, for the first and second group of polymers to become entangled as a polymeric network in the insulating layer;
wherein the first and second groups of polymers are deposited by wet-chemical dip-coating from their corresponding polymer solutions and/or wherein, prior to depositing the second group of polymers, part of the deposited first group of polymers is removed by dipping the electrode layer stack in a fluorocarbon solvent configured to dissolve the polymers of the first group of polymers to remove the unbonded polymers of the first group that are not covalently bonded to hydroxyl groups comprised in and attached to the electrode layer stack, and/or wherein between the step of depositing the first group of polymers and the removing part of the deposited first group of polymers, the method further comprises the step of annealing the electrode layer stack including the deposited first group of polymers, and wherein the step of annealing is performed at an elevated temperature of greater than 100° C., and/or wherein prior to the step of providing the insulating layer, the method further comprises the step of chemically-activating the first electrode layer to enable the covalent bonding with the first group of polymers.

39. The method according to claim 38, wherein prior to the step of providing the insulating layer, the method further comprises the successive steps of:
providing a support layer on the first electrode layer, the support layer comprising one or more materials chosen from the group formed by inorganic non-metallic materials having a high electrical resistivity and chemically cross-linked organic materials having a high electrical resistivity; and
chemically-activating the surface of the support layer to enable the covalent bonding with the first group of polymers in the insulating layer.

40. The method according to claim 39, wherein the step of chemically-activating includes providing the surface with hydroxyl groups.

41. A method for processing an electrode layer stack to manufacture an electrowetting optical element, the method comprising the steps of:
providing an electrode layer stack comprising a substrate and an electrode layer;
providing cell walls on the electrode layer stack and extending therefrom to define defining a three-dimensional non-planar topographic surface at least partially defining a containment space encapsulating a polar liquid and a non-polar liquid; and
providing an insulating layer on the electrode layer stack, over the electrode layer and the cell walls, forming an interface with the containment space;
wherein the insulating layer is formed by the successive steps of:
depositing a first group of polymers on the electrode layer stack, the first group of polymers including at least one functional hydrophilic chemical group configured to form covalent bonds with hydroxyl groups comprised in and attached to the electrode layer stack;
removing unbonded polymers of the first group that are not covalently bonded to the electrode layer stack; and
depositing a second group of polymers on the electrode layer stack, the second group of polymers including polymers without functional hydrophilic chemical groups;
allowing the first and second group of polymers to become entangled as a polymeric network in the insulating layer.
